(19) United States
(12) Patent Application Publication
(10) Pub. No.: US 2021/0329079 A1
(43) Pub. Date: Oct. 21, 2021

(54) METHODS, DEVICES AND COMPUTER-READABLE STORAGE MEDIA FOR PROCESSING A HOSTED APPLICATION

(71) Applicant: SHANGHAI ZHANGMEN SCIENCE AND TECHNOLOGY CO., LTD., Shanghai (CN)

(72) Inventors: Yong SU, Shanghai (CN); Fei Wang, Shanghai (CN)

(73) Assignee: SHANGHAI ZHANGMEN SCIENCE AND TECHNOLOGY CO., LTD., Shanghai (CN)

(21) Appl. No.: 17/359,680

(22) Filed: Jun. 28, 2021

Related U.S. Application Data
(63) Continuation of application No. PCT/CN2019/126896, filed on Dec. 20, 2019.

(30) Foreign Application Priority Data
Dec. 28, 2018 (CN) 201811620037.9

(51) Int. Cl. H04L 29/08; G06F 16/955

(52) U.S. Cl. CPC H04L 67/16; G06F 16/9554; H04L 67/146; H04L 67/141

(57) ABSTRACT

The present application provides a method, a device and a computer readable storage medium for processing a hosted application are described. An embodiment of the present disclosure obtains, by a first application, application function identification information of the hosted application of a second application according to accessible information of the hosted application, and in turn obtains, by the first application, an executable file for the hosted application and the application information of the second application according to the application function identification information, and the first application is enabled to execute the executable file for the hosted application with the application information of the second application.

### CROSS REFERENCE TO RELATED APPLICATIONS

The present application is a continuation application of an International Application No. PCT/CN2019/126896, filed on Dec. 20, 2019, which is based upon and claims priority to a Chinese Patent Application No. 201811620037.9, filed on Dec. 28, 2018, the entire contents of which are incorporated herein by reference.

### FIELD

The present disclosure relates to terminal application technologies, and more particularly relates to a method, device and computer-readable storage medium for processing a hosted application.

### BACKGROUND

With the development of communication technologies, a terminal is integrated with more and more functions, and more and more corresponding applications (APPs) are contained in a list of system functions of the terminal. Some applications (which may be referred to as host applications) can provide some specific services from other applications (which may be referred to as hosted applications), for example specific services provided by a variety of applets such as a Mobike applet, a credit card applet in WeChat APP etc. The hosted application may be utilized without being installed and may implement corresponding functions. The range of the specific services of the hosted applications provided by the host application is less than or equal to those provided by independent applications which can operate independently and correspond to the hosted applications.

However, since the hosted applications provided in the host application completely depend on the host application, these hosted applications can only operate in the host application, which reduces the reliability of the operation of the hosted applications.

### SUMMARY

Embodiments of the present disclosure provide methods, devices and computer-readable storage media for processing a hosted application to improve the reliability of the operation of the hosted application.

Embodiments of the present disclosure provide methods for processing a hosted application. The method includes:

obtaining, by a first application, application function identification information of the hosted application of a second application according to accessible information of the hosted application;

obtaining, by the first application, an executable file for the hosted application and application information of the second application according to the application function identification information; and

executing, by the first application, the executable file for the hosted application with the application information of the second application.

Another embodiment of the present disclosure provides a device. The device includes:

one or more processors; and

a storage means for storing one or more programs and the one or more programs, when executed by the one or more processors, cause the one or more processors to implement the method for processing a hosted application as provided in one of the above embodiments.

Yet another embodiment of the present disclosure provides a computer-readable storage medium storing computer programs thereon, and the programs, when executed by a processor, implement the method for processing a hosted application as provided in one of the above embodiments.

It can be seen from the embodiments of the present disclosure obtained, by a first application, application function identification information of the hosted application of a second application according to accessible information of the hosted application, and in turn obtain, by the first application, an executable file for the hosted application and the application information of the second application according to the application function identification information, so that the first application is enabled to execute the executable file for the hosted application with the application information of the second application. Since the hosted application of the second application does not depend on its host application (i.e., the second application) anymore, the hosted application is operable in any other third-party application (i.e., the first application) independently of its host application, which improves the reliability of the operation of the hosted application.

In addition, embodiments provided by the present disclosure is able to break the dependence of the hosted application on a single host application, so that the hosted application can be easily applied to any other third-party application (i.e., the first application) without requiring the host application (i.e., the second application) which provides the hosted application to be installed on the terminal, which extends the range of operation of the hosted application.

In addition, embodiments provided by the present disclosure is able to break the dependence of the hosted application on a single host application, so that the hosted application can be transplanted and easily applied to any other third-party application (i.e., the first application), which extends the range of operation of the hosted application.

In addition, embodiments provided by the present disclosure is able to enhance user experience effectively.

### DESCRIPTIONS OF THE DRAWINGS

In order to explain the embodiments of the present disclosure more clearly, drawings required to be used in the descriptions of embodiments or in the prior art will be briefly introduced below. The drawings described below are some embodiments of the present disclosure.

FIG. 1 is a schematic flowchart of a method for processing a hosted application provided by an embodiment of the present disclosure;

FIG. 2 is a block diagram of an exemplary computer system/server 12 suitable for implementing embodiments of the present disclosure.

### DETAILED EMBODIMENTS

It should be noted that the terminal involved in the embodiments of the present disclosure may include but is not limit to: a mobile phone, a personal digital assistant (PDA), a hand-held wireless device, a tablet computer, a personal computer (PC), an MP3 player, an MP4 player, a wearable device such as smart glasses, a smart watch, a smart wristband, etc.

In addition, the term “and/or” herein only refers to an association relationship which describes associated objects, and represents that there may be three relationships. For example, A and/or B may represent three situations: A exists alone, A and B exist at the same time, or B exists alone. In addition, the character “/” in this document generally represents that the associated objects before and after the character are in an “or” relationship.

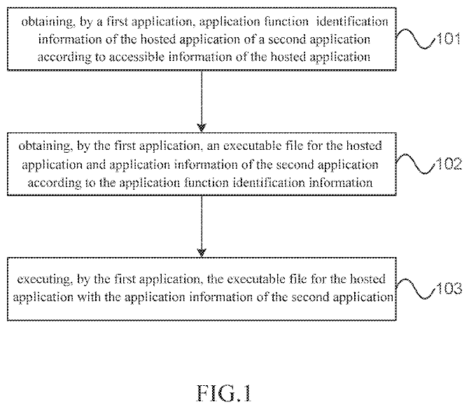

FIG. 1 is a schematic flowchart of a method for processing a hosted application provided by an embodiment of the present disclosure. As shown in FIG. 1,

at 101, a first application obtains application function identification information of the hosted application of a second application according to accessible information of the hosted application.

At this time, the operating system of a terminal is running the first application. The so-called running means that the operating system of the terminal is run by a window in the foreground.

The so-called second application refers to a host application which provides the hosted application, such as WeChat application, QQ application, etc.

At 102, the first application obtains an executable file for the hosted application and application information of the second application according to the application function identification information.

The application information of the second application refers to some information related to the operation of the second application, such as registration and login information, application management information, etc.

At 103, the first application executes the executable file for the hosted application with the application information of the second application.

It should be noted that the first application may be a native application (nativeApp) installed on the terminal, or may be a webpage application (webApp) of a browser on the terminal, which is not limited in the embodiment. The second application may be a native application (nativeApp) installed on the terminal, or may be an application which is not installed on the terminal, or may be a webpage application (webApp) of a browser on the terminal, which is not limited in the embodiment. For example, the second application may be a social networking service (SNS) application, an instant messaging (IM) application, etc. installed on the terminal. The type of the second application is not limited in the embodiment.

The hosted application may be a native application (i.e., an applet) which is not required to be installed on the terminal and is triggered to operate by a user of the second application, and may be referred to as a hosted application.

A main idea of the present application lies in that: a third-party application (i.e., the first application) can execute the executable file for the hosted application directly with the application information of the second application without invoking the host application corresponding to the hosted application (i.e., the second application).

In this way, a first application obtains application function identification information of the hosted application of a second application according to accessible information of the hosted application, and in turn the first application obtains an executable file for the hosted application and the application information of the second application according to the application function identification information, so that the first application is enabled to execute the executable file for the hosted application with the application information of the second application. Since the hosted application of the second application does not depend on its host application (i.e., the second application) anymore, the hosted application is operable in any other third-party application (i.e., the first application) independently of its host application, which improves the reliability of the operation of the hosted application.

In the present application, the first application may be associated with one or more second applications. All of the hosted applications of different second applications such as WeChat applet, Alipay applet, Baidu applet, and Toutiao applet, etc. may be operated through the first application as an interaction entrance during user interaction. The operations of the respective hosted applications of these second applications are mutually incompatible and independent of each other. Users do not need to determine and select which specific second application to operate when facing accessible information of different hosted applications. Instead, the hosted application may be operated through a uniform interactive interface (i.e., the first application), which can reflect compatibility better and simplify user operations.

In the present application, the first application may further be associated with at least one second application in advance to construct an association relationship between a third-party application and multiple host applications. In this way, when the respective hosted applications of these host applications are invoked, the first application may execute executable files for the hosted applications directly with application information of these second applications without invoking the host applications (i.e., the second applications) corresponding to the hosted applications.

O Embodiments, specifically in 102, the first application may obtain the executable file for the hosted application according to the application function identification information of the hosted application, and determine an application as the second application corresponding to the hosted application from at least one associated application which has been associated with the first application, and obtain the application information of the second application.

O Embodiments, at 101, the accessible information of the hosted application utilized by the first application may include, but is not limited to: a uniform resource locator (URL) information of the hosted application or bar code information of the hosted application, which is not specifically limited in the embodiment.

The bar code information may include, but is not limited to: a one-dimensional bar code or a two-dimensional bar code, which is not specifically limited in the embodiment. Specifically, the detailed description for the one-dimensional bar code and the two-dimensional bar code may be referred to the related content in the prior art respectively, which will not be repeated here.

In a specific implementation, the application function identification information of the hosted application obtained by the first application may be directly configured as the accessible information of the hosted application, such as URL information of the hosted application.

Specifically, the first application may receive the URL information directly with the messaging function of the first application.

In another specific implementation, the application function identification information of the hosted application obtained by the first application may be configured in the accessible information of the hosted application, such as bar code information of the hosted application.

Specifically, the first application may scan the bar code information advertised on public publications or advertising areas in public places with a scanning function of the first application, and in turn continue to decode the scanned bar code information with a decoding function of the first application, to obtain the URL information contained in the bar code information.

Embodiment, the hosted application may be operated directly by means of a page jump in an application. In one embodiment, the hosted application may be operated by means of a page jump between applications, which is not specifically limited in the embodiment.

For page jump in an application, the application function identification information of the hosted application may be in a form of an application interface, such as an appid interface, etc.

For page jump between applications, the application function identification information of the hosted application may be in a form of a page jump protocol in IOS system or Android system, for example, in a form of a uniform resource locator (URL) scheme protocol such as weixin://appbrand/appid, and the weixin represents Software Development Kit (SDK) of the hosted application. The SDK of the hosted application contains the executable file for the hosted application used to realize operation of the hosted application by executing the executable file for the hosted application. In one embodiment, the application function identification information of the hosted application may also be in a form of a system interface in Android system, for example, in a form of an intent object interface and a bundle object interface, etc., which is not specifically limited in the embodiment.

In a specific implementation, the application function identification information of the hosted application may include but is not limited to application identification information of the hosted application, which is not specifically limited in the embodiment. At this time, the application function identification information of the hosted application may indicate to operate the hosted application in the first application to open a default page of the hosted application such as a home page of an applet.

The application identification information of the hosted application may include but is not limited to a brand of the hosted application (appbrand) and an identifier of the hosted application (appid), which is not specifically limited in the embodiment. The brand of the hosted application (appbrand) is used to indicate functions of the hosted application. The identifier of the hosted application (appid) is used to indicate the hosted application.

As an example, the application identification information of the hosted application may be weixin://appbrand/appid, etc.

In another specific implementation, the application function identification information of the hosted application may include the application identification information of the hosted application and the page identification information (page) of the hosted application. At this time, the application function identification information of the hosted application may indicate to operate the hosted application in the first application to open a designated page of the hosted application, i.e., an applet page identified by the page identification information (page), etc.

The application identification information of the hosted application may include but is not limited to a brand of the hosted application (appbrand) and an identifier of the hosted application (appid), which is not specifically limited in the embodiment. The brand of the hosted application (appbrand) is used to indicate functions of the hosted application. The identifier of the hosted application (appid) is used to indicate the hosted application.

As an example, the application identification information of the hosted application may be weixin://appbrand/appid, etc.

As another example, the application function identification information of the hosted application may be weixin://appbrand/appid/page.

On the basis of the above two specific implementations, the application function identification information of the hosted application may further include parameter information required by the application function. At this time, the parameter information required by the application function may indicate some parameters required when the hosted application of the second application is operating in the first application. As an example, a starting point and an ending point of a query are required when a map applet in the WeChat application is operating in the DianPing application for route planning. In one embodiment, as another example, a departure date and a return date are required when a flight ticket applet in the WeChat application is operating in the DianPing application for trip planning, and so on.

Specifically in the present disclosure, the executable file for the hosted application and the application information of the second application obtained by the first application may be encapsulated in an SDK of the hosted application, so that the first application may operate the hosted application by executing the SDK of the hosted application.

Embodiments, specifically in 102, the first application may obtain the executable file for the hosted application and the application information of the second application from the first application according to the application function identification information of the hosted application.

Specifically, executable files for multiple hosted applications and application information of a host application (i.e., the second application) corresponding to each of the hosted applications, as well as application function identification information of the hosted application corresponding to the host application may be pre-stored in the first application.

Embodiments, specifically in 102, the first application may obtain the executable file for the hosted application and the application information of the second application from an application server for the second application according to the application function identification information of the hosted application.

After the executable file for the hosted application and the application information of the second application are obtained, in order to improve the execution efficiency for the next execution of the executable file for the hosted application, the first application may further store the executable file for the hosted application and the application information of the second application in the first application, so that the first application obtains the executable file for the hosted application and the application information of the second application directly from the first application according to the application function identification information of the hosted application.

In these embodiments, a first application obtains application function identification information of the hosted application of a second application according to accessible information of the hosted application, and in turn the first application obtains an executable file for the hosted application and the application information of the second application according to the application function identification information, so that the first application is enabled to execute the executable file for the hosted application with the application information of the second application. Since the hosted application of the second application does not depend on its host application (i.e., the second application) anymore, the hosted application is operable in any other third-party application (i.e., the first application) independently of its host application, which improves the reliability of the operation of the hosted application.

In addition, the embodiments provided by the present disclosure is able to break the dependence of the hosted application on a single host application, so that the hosted application can be easily applied to any other third-party application (i.e., the first application) without requiring the host application (i.e., the second application) which provides the hosted application to be installed on the terminal, which extends the range of operation of the hosted application.

In addition, the embodiments provided by the present disclosure is able to break the dependence of the hosted application on a single host application, so that the hosted application can be transplanted and easily applied to any other third-party application (i.e., the first application), which extends the range of operation of the hosted application.

In addition, the embodiments provided by the present disclosure is able to enhance user experience effectively.

In the above embodiments, the description of each embodiment has its own emphasis. For a part that is not described in detail in an embodiment, reference may be made to related descriptions in other embodiments.

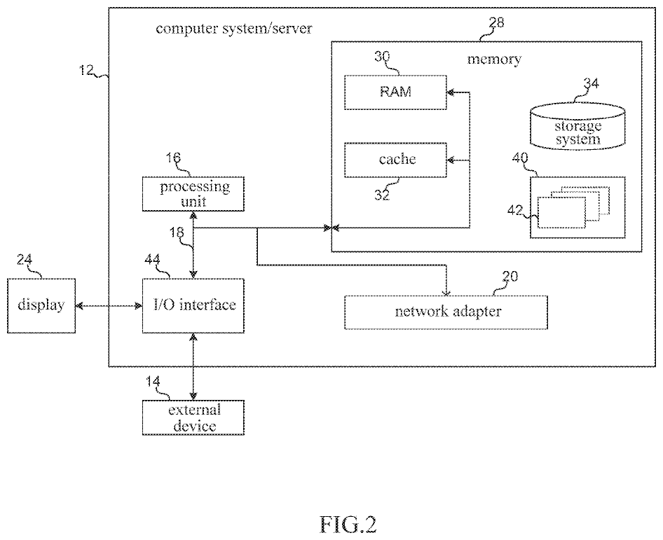

FIG. 2 shows a block diagram of an exemplary computer system/server 12 suitable for implementing the embodiments of the present disclosure. The computer system/server 12 shown in FIG. 2 is merely an example, and should not impose any limitation on the functions and scope of use of the embodiments of the present application.

As shown in FIG. 2, the computer system/server 12 is embodied as a general-purpose computing device. Components of the computer system/server 12 may include but are not limited to one or more processors or processing units 16, a storage means or a system memory 28, a bus 18 connecting different system components (including the system memory 28 and the processing unit 16).

The bus 18 represents one or more of several types of bus structures, including a memory bus or a memory controller, a peripheral bus, a graphics acceleration port, a processor, or a local area bus using any of a variety of bus structures. By way of example, these architectures include, but are not limited to, an Industry Standard Architecture (ISA) bus, a Micro Channel Architecture (MAC) bus, an enhanced ISA bus, a Video Electronics Standards Association (VESA) local area bus, and a peripheral component interconnect (PCI) bus.

Computer system/server 12 typically includes a variety of computer system readable media. These media can be any available media that can be accessed by the computer system/server 12, including volatile and non-volatile media, removable and non-removable media.

The system memory 28 may include computer system readable media in the form of a volatile memory, such as a random access memory (RAM) 30 and/or a cache memory 32. The computer system/server 12 may further include other removable/non-removable, volatile/nonvolatile computer system storage media. By way of example only, the storage system 34 may be used to read and write a non-removable, non-volatile magnetic medium (not shown in FIG. 2 and is commonly referred to as a “hard drive”). Although not shown in FIG. 2, a magnetic disk drive for reading and writing to a removable non-volatile magnetic disk (for example, “a floppy disk”) and an optical disk drive for reading and writing to a removable non-volatile optical disk (for example, CD-ROM, DVD-ROM or other optical media) may be provided. In these cases, each drive may be connected to the bus 18 through one or more data media interfaces. The system memory 28 may include at least one program product having a set of (e.g., at least one) program modules configured to perform the functions of the embodiments of the present disclosure.

A program/utility tool 40 having a set of (at least one) program modules 42 may be stored in, for example, the system memory 28. Such program modules 42 include, but are not limited to, an operating system, one or more application programs, other programs modules and program data, each or some combination of these examples may include implementations of the network environment. The program modules 42 generally perform functions and/or methods in the embodiments described in the present disclosure.

The computer system/server 12 can also communicate with one or more external devices 14 (e.g., a keyboard, a pointing device, a display 24, etc.), and can also communicate with one or more devices that enable users to interact with the computer system/server 12, and/or with any device (such as a network card, a modem, etc.) that enables the computer system/server 12 to communicate with one or more other computing devices. Such communication can be performed through an input/output (I/O) interface 44. Moreover, the computer system/server 12 can also communicate with one or more networks (such as a local area network (LAN), a wide area network (WAN), and/or a public network, such as the Internet) through a network adapter 20. As shown in the figures, the network adapter 20 communicates with other modules of the computer system/server 12 through the bus 18. It should be understood that although not shown in the figures, other hardware and/or software modules may be used in conjunction with the computer system/server 12, including but not limited to: microcode, device drivers, redundant processing units, external disk drive arrays, RAID systems, tape drives and data backup storage systems.

The processing unit 16 executes programs stored in the system memory 28 to execute various functional applications and data processing, for example, to implement the method for processing a hosted application provided in any one of the embodiments corresponding to FIG. 1.

Another embodiment of the present disclosure also provides a computer-readable storage medium storing computer programs thereon. The programs, when executed by a processor, implement the method for processing a hosted application provided in any one of the embodiments corresponding to FIG. 1.

In specific, any combination of one or more computer-readable media may be used. The computer-readable media may be computer-readable signal media or computer-readable storage media. The computer-readable storage media may be, for example, but not limited to, an electronic, magnetic, optical, electromagnetic, infrared, or semiconductor system, apparatus, or device, or any combination thereof. More specific examples (non-exhaustive list) of computer-readable storage media may include: electrical connections with one or more wires, portable computer magnetic disks, hard disks, a random access memory (RAM), a read-only memory (ROM), an erasable programming read-only memory (EPROM or flash memory), an optical fiber, a portable compact disk read-only memory (CD-ROM), an optical storage device, a magnetic storage device, or any suitable combination of the foregoing. In the present document, the computer-readable storage media may be any tangible media that contain or store programs that can be used by or in combination with an instruction execution system, apparatus, or device.

Computer-readable signal media may include a data signal that is included in a baseband or propagated as part of a carrier wave, and which carries computer-readable program code. Such a propagated data signal may take many forms, including but not limited to electromagnetic signals, optical signals, or any suitable combination of the foregoing. The computer-readable signal media may also be any computer-readable media other than computer-readable storage media, and the computer-readable media may send, propagate, or transmit a program for use by or in connection with an instruction execution system, apparatus or device.

Program code embodied on computer-readable media may be transmitted using any appropriate media, including but not limited to: wireless, wired, optical fiber cable, RF, etc., or any suitable combination of the foregoing.

Computer program code for performing the operations of the present disclosure may be written in one or more programming languages, or a combination thereof, including object oriented programming languages such as Java, Smalltalk, C++, and conventional procedural programming language, such as “C” or similar programming language. The program code can be executed entirely on the user's computer, partly on the user's computer, as an independent software package, partly on the user's computer and partly on a remote computer, or entirely on a remote computer or server. In the case of a remote computer, the remote computer can be connected to the user's computer through any kind of network, including a local area network (LAN) or wide area network (WAN), or it can be connected to an external computer (for example through Internet connection provided by an Internet service provider).

In the several embodiments provided by the present disclosure, it should be understood that the disclosed system, apparatus and method etc., may be implemented in other ways. By way of example, the apparatus embodiments described above are merely schematic. For example, the division of the units is only a logical function division, and there may be another division manner in actual implementation. As an example, multiple units or page components may be combined or integrated into another system. In one embodiment, some features may be ignored or not implemented. As another example, mutual coupling or direct coupling or communication connection demonstrated or discussed herein may be indirect coupling or communication connection through some interfaces, apparatuses or units, and may be electrical, mechanical or in other forms.

The units described as separate components may or may not be physically separated, and the components displayed as units may or may not be physical units. They may be located in one place, or may be distributed on multiple network units. Some or all of the units may be selected according to actual needs to achieve the objective of the solution of the embodiment.

In addition, each functional unit in the embodiments of the present disclosure may be integrated into one processing unit, or each unit may exist separately physically, or two or more units may be integrated into one unit. The above integrated unit may be implemented in the form of hardware, or in the form of hardware plus software functional units.

The above integrated unit implemented in the form of a software functional unit may be stored in a computer-readable storage medium. The above software functional unit is stored in a storage medium and includes several instructions for causing a computer device (which may be a personal computer, a server, or a network device) or a processor to execute some steps of the methods described in the embodiments of the present disclosure. The foregoing storage medium includes various media that can store program codes, such as a U disk, a mobile hard disk, a read-only memory (ROM), a random access memory (RAM), a magnetic disk, or an optical disc.

What is claimed is:

1. A method for processing a hosted application, comprising:
obtaining, by a first application, application function identification information of the hosted application of a second application according to accessible information of the hosted application;
obtaining, by the first application, an executable file for the hosted application and application information of the second application according to the application function identification information; and
executing, by the first application, the executable file for the hosted application with the application information of the second application.

2. The method according to claim 1, wherein obtaining, by the first application, an executable file for the hosted application and the application information of the second application according to the application function identification information of the hosted application comprising:
obtaining, by the first application, the executable file for the hosted application according to the application function identification information of the hosted application, and determining an applications as the second application corresponding to the hosted application from at least one associated application which has been associated with the first application, and obtaining the application information of the second application.

3. The method according to claim 1, wherein the accessible information of the hosted application comprises URL information of the hosted application or bar code information of the hosted application.

4. The method according to claim 1, wherein the application function identification information of the hosted application is in form of an application interface, a page jump protocol, or a system interface.

5. The method according to claim 1, wherein the application function identification information of the hosted application comprises:
application identification information of the hosted application; or
application identification information of the hosted application and page identification information of the hosted application.

6. The method according to claim 5, wherein the application identification information of the hosted application comprises a brand of the hosted application and an identifier of the hosted application.

7. The method according to claim 5, wherein the application function identification information of the hosted application further comprises parameter information required by the application function identification information.

8. The method according to claim 1, wherein obtaining, by the first application, the executable file for the hosted application and the application information of the second application according to the application function identification information of the hosted application comprising:
obtaining, by the first application, the executable file for the hosted application and the application information of the second application from the first application according to the application function identification information of the hosted application; or obtaining, by the first application, the executable file for the hosted application and the application information of the second application from an application server for the second application according to the application function identification information of the hosted application.

9. The method according to claim 8, wherein after obtaining, by the first application, the executable file for the hosted application and the application information of the second application from an application server for the second application according to the application function identification information of the hosted application, the method further comprising:
storing, by the first application, the executable file for the hosted application and the application information of the second application in the first application.

10. A device, comprising:
one or more processors; and
a storage device for storing one or more programs,
wherein the one or more programs, when executed by the one or more processors, cause the one or more processors to:
obtain, by a first application, application function identification information of a hosted application of a second application according to accessible information of the hosted application;
obtain, by the first application, an executable file for the hosted application and application information of the second application according to the application function identification information; and
execute, by the first application, the executable file for the hosted application with the application information of the second application.

11. A computer-readable storage medium storing computer programs thereon, wherein the computer programs, when executed by a processor, causing the processor to:
obtain, by a first application, application function identification information of a hosted application of a second application according to accessible information of the hosted application;
obtain, by the first application, an executable file for the hosted application and application information of the second application according to the application function identification information; and
execute, by the first application, the executable file for the hosted application with the application information of the second application.
